(19) United States
(12) Patent Application Publication
(10) Pub. No.: US 2004/0241614 A1
(43) Pub. Date: Dec. 2, 2004

(54) Prefabricated components for dental appliances

(76) Inventors: A. Jon Goldberg, West Hartford, CT (US); Patrick T. Mather, Storrs, CT (US); Robert A. Weiss, Mansfield, CT (US); Pichet Rojanapitayakorn, Bangkoknoi (TH); Ajit Karmaker, Wallingford, CT (US); Arun Prasad, Cheshire, CT (US)

Correspondence Address: PENTRON CORPORATION, 53 NORTH PLAINS INDUSTRIAL ROAD, WALLINGFORD, CT, 06492, US

(21) Appl. No.: 10/744,282

(22) Filed: Dec. 22, 2003

Related U.S. Application Data
(63) Continuation-in-part of application No. 10/029,782, filed on Oct. 26, 2001.
Application No. 10/029,782 is a continuation of application No. 09/344,089, filed on Jun. 25, 1999, now Pat. No. 6,345,984.
Application No. 09/344,089 is a continuation-in-part of application No. 09/190,806, filed on Nov. 12, 1998, now Pat. No. 6,186,790.
Application No. 09/190,806 is a continuation-in-part of application No. 09/059,492, filed on Apr. 13, 1998, now abandoned.

(51) Int. Cl. A61C 13/08; B29B 7/00

(52) U.S. Cl. 433/202.1; 428/542.8

(57) ABSTRACT

CADCAM blocks are prepared in a variety of shapes and sizes to be used in the fabrication of dental appliances. The blocks are fabricated of a fiber-reinforced composite material wherein the fibers may be randomly dispersed to provide blocks having isotropic properties. The polymeric matrix is partially or fully cured to the point of sufficient hardness to provide a ready-to-use structural component for use in the fabrication of dental appliances such as orthodontic retainers, bridges, space maintainers, tooth replacement appliances, splints, crowns, partial crowns, dentures, posts, teeth, jackets, inlays, onlays, facings, veneers, facets, implants, abutments, retainers, cylinders, and connectors.

### CROSS-REFERENCE TO RELATED APPLICATIONS

This is a continuation-in-part application of U.S. application Ser. No. 10/029,782, which is a continuation application of application Ser. No. 09/344,089, now U.S. Pat. No. 6,345,984, which is a continuation-in-part application of application Ser. No. 09/190,806, now U.S. Pat. No. 6,186,790, which is a continuation-in-part application of application Ser. No. 09/059,492, now abandoned.

### TECHNICAL FIELD

The present invention relates generally to dental appliances and restorations and more particularly to prefabricated components for use in dental appliances and restorations and methods of manufacture thereof.

### BACKGROUND OF THE INVENTION

Dental appliances and restorations such as bridges, crowns, dentures and the like may be used to restore a missing tooth and retain natural teeth in position and prevent migration subsequent to orthodontic treatment. Structural components used in these appliances often include wires, bars, posts, shells, beams, clasps and other shapes. The shape of the structural components may vary depending upon the requirements of the appliance.

The manufacture of frameworks for bridges using current techniques can be time consuming and labor intensive. Some techniques may involve taking uncured fiber-reinforced composite material and forming uncured strips of the fiber-reinforced composite material into a bridge framework upon a dental cast. The procedure can be an involved and complex process depending upon the final shape desired. Moreover, dental technicians and practitioners may use less than the optimum amount of fiber for reinforcement when preparing the dental framework in order to reduce the cost which may lead to low strength and therefore potential fracture of the final product. Furthermore, the complexity of the dental appliance may require a certain dexterity to achieve optimal properties that may not be achievable by some technicians and practitioners.

Other types of materials such as metals, alloys and ceramics have been used with great success in the manufacture of dental restorations and have exhibited flexural strengths as high as 300 MPa and above. Unfortunately, the aesthetic appearance is sometimes less than pleasing due to the unfavorable light transmission properties of these materials.

There remains a need to simplify the process of fabricating dental appliances to reduce time and labor involved in the preparation process and to provide appliances having optimum properties. It is desirable to reduce the risk of contamination during the fabrication of dental appliances. It is desirable to maintain strength of dental appliances without sacrificing aesthetic and light transmission properties.

### SUMMARY OF THE INVENTION

These and other objects and advantages are accomplished by the present invention wherein preshaped, prefabricated cured or otherwise solid components are prepared in a variety of shapes and sizes to be used in the fabrication of dental appliances. Preferably the components are fabricated of a fiber-reinforced composite material comprising fibers impregnated with a polymeric matrix. After impregnation of a fibrous material with a polymeric matrix or vice versa, the resultant fiber-reinforced composite material is shaped and is partially or fully cured to the point of sufficient hardness to provide a component for use in the fabrication of dental appliances including but not limited to orthodontic retainers, bridges, space maintainers, tooth replacement appliances, dentures, crowns, posts, jackets, inlays, onlays, facings, veneers, facets, implants, abutments and splints.

In one embodiment of the present invention, the components are in the shape of a structure for immediate use in the fabrication of a dental appliance. The structural components are formed into any known shapes useful in the fabrication of a dental appliance or restoration. Preferably, the structural components are in the shape of bars or pontics. The pontics have interproximal extensions and may be single unit or multiple unit useful in the fabrication of frameworks for bridges. The structural components may be “ready-to-use” for immediate use in the fabrication of a dental appliance or restoration or may be further modified, for example by cutting, carving or grinding prior to using in the fabrication of a dental appliance or restoration.

In another embodiment of the present invention, the components are formed into pieces or blocks of fiber-reinforced composite material. The blocks of material are useful in making a variety of shapes and sizes and may be modified by a variety of methods including but not limited to machining, carving, cutting, grinding, etching and abrading.

The bars, pontics and blocks may be of any cross-sectional configuration effective to provide strength and stiffness to the finished dental appliance.

In yet another embodiment herein, blocks of particulate filled composite material are formed and may be provided in a variety of shapes and sizes. The particulate filled composite blocks may be modified by a variety of methods including but not limited to machining, carving, cutting, grinding, etching and abrading. The blocks may be of any cross-sectional configuration effective to design or model dental materials and restorations therefrom.

In still another embodiment herein, blocks, pontics or bars of composite material are formed having fibers not fully aligned in one direction of the block so that some of the fibers are randomly dispersed in at least one section of the block, some of the fibers are aligned in at least one section of the block and in at least one section of the block, some of the fibers are oriented in a another direction different from the direction of the aligned fibers. The blocks are used in the manufacture of dental restorations by machining, carving, cutting, grinding, etching and/or abrading the blocks to form the dental appliance.

In the method of the present invention, the components are made after the impregnation of the fibers with a polymeric matrix. After impregnation of the fibers, the resultant composite material is formed into, for example, a long bar and cured or processed to a hardness whereby the bar may be cut and/or machined without deforming the structural integrity of the bar. The bar is preferably cut into short segments and is ready for use in the fabrication of dental appliances, such as, for example, orthodontic retainers, bridges, space maintainers, tooth replacement appliances, splints, crowns, partial crowns, dentures, posts, teeth, jackets, inlays, onlays, facings, veneers, facets, implants, abutments, cylinders, and connectors.

The bars may be used as is or may be further modified by cutting, grinding, machining, and the like to provide a specifically shaped or customized component. The component may further be veneered with particulate-filled composite to develop clinically acceptable anatomy.

### BRIEF DESCRIPTION OF THE DRAWINGS

Features of the present invention are disclosed in the accompanying drawings, wherein similar reference characters denote similar elements throughout the several views, and wherein:

FIG. 1 is a perspective view of bars of different shapes that may be formed in accordance with the present invention;

FIG. 2 is a front elevational view of a multi-unit pontic formed in accordance with the present invention;

FIG. 3 is a top plan view of a multi-unit pontic formed in accordance with the present invention;

FIG. 4 is a top plan view of a series of molds used to fabricate solid or thermoset single unit pontics in accordance with the present invention;

FIG. 5 is a front elevational view of a thermoset single unit pontic formed using a mold in FIG. 4; and

FIG. 6 is a side elevational view of a mold used to fabricate thermoset long bars in accordance with the present invention.

FIG. 7 is a perspective view of a cylindrical block formed in accordance with the present invention;

FIG. 8 is a perspective view of a tooth machined out of the block shown in FIG. 7;

FIG. 9 is a perspective view of a rectangular block formed in accordance with the present invention;

FIG. 10 is a perspective view of a bridge machined out of the block shown in FIG. 9;

FIG. 11 is a perspective view of a square block formed in accordance with the present invention;

FIG. 12 is a perspective view of a cylinder machined out of the block shown in FIG. 11;

FIG. 13 is a perspective view of a partial implant system formed from structural components of the present invention;

FIG. 14 is a perspective view of a curved rectangular block formed in accordance with the present invention;

FIG. 15 is a perspective view of an implant superstructure machined out of the block shown in FIG. 14;

FIG. 16 is a top plan view of a block formed in accordance herein and showing the orientation of the fibers in the composite;

FIG. 17 is a cross-sectional view of the bar of FIG. 16 sliced at line 17-17 showing the orientation of the fibers in the composite;

FIG. 18 is a cross-sectional side elevational view of a framework machined from the block shown in FIG. 16;

FIG. 19 is a top plan view of the framework shown in FIG. 18;

FIG. 20 is a side elevational view of the framework shown in FIG. 18 positioned on a set of steel dies;

FIG. 21 is a graph comparing the mechanical properties of the samples from the examples having 1.25 mm thickness in the retainer sections of the framework; and

FIG. 22 is a graph comparing the mechanical properties of samples from the examples having 0.75 mm thickness in the retainer sections of the framework.

### DETAILED DESCRIPTION

The prefabricated components in accordance with the present invention are preferably formed from a fiber-reinforced composite material comprising a polymeric matrix and reinforcing fibers within the matrix. The fibers are embedded in the matrix manually or mechanically by a variety of techniques including, but not limited to twin-screw extrusion, matched die processes, autoclave molding, resin injection molding (RIM), sheet, dough and bulk molding, press molding, injection molding, reaction injection molding, resin transfer molding (RTM), compression molding, open molding, extrusion, pultrusion and filament winding. U.S. Pat. Nos. 4,717,341 and 4,894,012 to Goldberg et al. show methods of impregnation and are hereby incorporated by reference. Preferably, the fiber-reinforced polymeric matrix is formed using the twin-screw extrusion and/or injection molding techniques.

Alternatively, the prefabricated components are formed from a particulate-filled composite material comprising a polymeric matrix and particulate filler within the matrix. Preferably, the prefabricated components of particulate filled composite material are formed into blocks of material of a variety of shapes and sizes which can thereafter be modified by a variety of methods including but not limited to machining, carving, cutting, grinding, etching and abrading. Preferably, the blocks of material are useful in CAD CAM processes and equipment in the fabrication of dental restorations.

The polymeric matrix element of the fiber-reinforced and particulate-filled composites is selected from a thermoset or thermoplastic resin known in the art of dental materials, including but not being limited to polyamides, polyesters, polyolefins, polyimides, polyarylates, polymethacrylates, polyacrylates, polyurethanes, vinyl esters or epoxy-based materials. Polymethacrylate refers to polymers including, but not restricted to, polymethacrylate, poly(methyl methacrylate), poly(ethyl methacrylate), other poly(n-alkyl methacrylates), and poly(t-butyl methacrylate). Other polymeric matrices include polystyrenes, polystyrene acrylonitriles, ABS polymers, polysulfones, polyacetals, polycarbonates, polyphenylene sulfides, polyketones, liquid crystalline polymers, polysiloxanes, polyphoshazenes, thermoplastic polyesters, thermoplastic polyurethanes, polyethylenes, polyethers, and the like. Random block and graft copolymers and ionomers represent other possible matrices.

Examples of thermoset polymeric materials include those based on acrylic and methacrylic monomers, for example those disclosed in U.S. Pat. Nos. 3,066,112, 3,179,623, and 3,194,784 to Bowen; U.S. Pat. Nos. 3,751,399 and 3,926,906 to Lee et al.; commonly assigned U.S. Pat. Nos. 5,276,068 and 5,444,104 to Waknine; and commonly assigned U.S. Pat. No. 5,684,103 to Jia et al., the pertinent portions of all which are herein incorporated by reference. An example of a methacrylate monomer is the condensation product of bisphenol A and glycidyl methacrylate, 2,2′-bis[4-(3-methacryloxy-2-hydroxy propoxy)-phenyl]-propane (hereinafter abbreviated “BIS-GMA”). Polyurethane dimethacrylates (hereinafter abbreviated “PUDMA”), triethylene glycol dimethacrylate (hereinafter abbreviated “TEGDMA”), polyethylene glycol dimethacrylate (hereinafter abbreviated “PEGDMA”), polycarbonate dimethacrylate (hereinafter abbreviated “PCDMA”) and ethoxylated bisphenol A dimethacrylate (hereinafter abbreviated “EBPADMA”) are also commonly-used principal polymers suitable for use in the present invention.

Preferred thermoplastic polymers include polyphenylene sulfide, polyether ketone ketone, polyether ether ketone, nylon 6/66, nylon 6/6, nylon 6, nylon 4/6, polyethylene terephthalate, thermoplastic polyurethane, and polybutylene terephthalate.

The polymer matrix may include polymerization initiators, polymerization accelerators, ultraviolet light absorbers, anti-oxidants, and other additives well known in the art. The polymer matrices may be visible light curable, self-curing, dual curing, and vacuum, heat, and pressure curable compositions as well as any combination thereof. The visible light curable compositions include the usual polymerization initiators, polymerization accelerators, ultraviolet absorbers, fluorescent whitening agents, and the like. Preferred light curing initiators include camphorquinone (CQ) and trimethyl benzoyl phosphine oxide (TPO). The heat curable compositions, which are generally filled compositions, include, in addition to the monomeric components, a heat cure initiator such as benzoyl peroxide, 1,1′-azobis(cyclohexanecarbo-nitrile), or other free radical initiators.

An example of a particulate-filled polymeric matrix is a heat curable polymeric matrix comprising one or more heat initiators mentioned above. The polymeric matrix of the particulate-filled composite comprises a resinous dental composition as set forth in commonly owned U.S. Pat. No. 5,969,000, which is hereby incorporated by reference which is derived from the reaction of an ethoxylated bisphenol A dimethacrylate and a co-monomer, preferably a polycarbonate dimethacrylate condensation product described in U.S. Pat. Nos. 5,276,068 and 5,444,104 to Waknine and more preferably a dimethacrylate oligomer. The resinous dental composition can additionally include a third, diluent monomer to increase the surface wettability of the resinous matrix. The ethoxylated bisphenol A dimethacrylate in accordance with the present invention has the following structure:

CH₂═C(CH₃)CO₂(C₂H₄O)ₓC₆H₄C(CH₃)₂C₆H₄(OC₂H₄)_{y}O₂CC(CH₃)═CH₂ wherein x+y is an integer from 1 to 20, and preferably an integer from 2 to 7. Such material is available from Sartomer® under the trade name SR348 or SR480, or from Esschem.

The polycarbonate dimethacrylate condensation product co-monomer results from the condensation, under carefully controlled conditions, of two parts by weight of a hydroxyalkylmethacrylate of the formula H₂C═C(CH₃)C(O)O—A—OH, in which A is a C₁-C₆ alkylene, with 1 part by weight of a bis(chloroformate) of the formula ClC(O)—(OR)ₙ—OC(O)Cl, in which R is a C₂-C₅ having at least two carbon atoms in its principal chain, and n is an integer in the range from 1 to 4.

Preferably, the ethoxylated bisphenol A dimethacrylate is used in an amount in the range from about 65 to about 90 percent by weight of the total resin composition which forms the polymeric matrix. More preferably, the ethoxylated bisphenol A dimethacrylate is used in an amount in the range from about 70 to about 80 percent by weight of the total resin composition. Typically, the dimethacrylate oligomer, preferably a polycarbonate dimethacrylate, is incorporated into the resinous composition in an amount from about 10 to about 30 weight percent of the total resin composition. Optionally, a diluent is present in an amount from about 0 to about 40 weight percent of the total resin composition.

When no diluent component is employed, the preferred range for the ethoxylated bisphenol A dimethacrylates is from about 65 to about 90 weight percent, and most preferably about 70 weight percent of the total resin composition, and the preferred range for the dimethacrylate oligomer is from about 10 to about 30 weight percent, and most preferably about 30 weight percent of the total resin composition which forms the polymeric matrix.

The reinforcing fiber element of the fiber-reinforced composite preferably comprises glass, carbon, graphite, carbon nano-tubes, polyaramid, or other fibers known in the art, such as polyesters, polyamides, and other natural and synthetic materials compatible with the polymeric matrix. Some of the aforementioned fibrous materials are disclosed in commonly assigned copending U.S. Pat. No. 6,013,694, and U.S. Pat. Nos. 4,717,341 and 4,894,012, all which are incorporated herein by reference. The fibers may further be treated, for example, chemically or mechanically etched and/or silanized, to enhance the bond between the fibers and the polymeric matrix. The fibers may further be covalently or physically bonded to the polymeric matrix itself or to a coupling agent that is covalently or physically bonded to both. Additionally, thermoplastic matrices may be treated to improve adhesion to the fiber by methods known in the art such as with the addition of compatibilizers or by functionalization of the polymer via plasma treatments, oxidation, reduction or other chemical or radiation treatments.

The fibers may take the form of short or long filaments in the size range of from about 5 nm to about 11 mm, and preferably from about 5 mm to about 11 mm. The fibers may be partially aligned and oriented along the longitudinal dimensions of the long dimension of the structure, or the fibers may also be otherwise oriented, including being normal or perpendicular to that dimension, randomly dispersed, or a combination thereof. The fibrous element may optionally take the form of a fabric. Fabric may be of the woven or non-woven type and is preferably preimpregnated with a polymeric material as set forth above. Examples of suitable woven fabric materials include but are not limited to those known in the art such as E glass and S glass fabrics and reinforcement fabrics sold by NFGS Inc. of New Hampshire under the style numbers 6522 and 7581. One preferred non-woven fabric material is available under the name Glass Tissue (20103A) from Technical Fibre Products Ltd. of Slate Hill, N.Y. The fibrous component may be present in the fiber reinforced composite material in the range from about 20% to about 85%, and more preferably between about 30% to about 65% by weight.

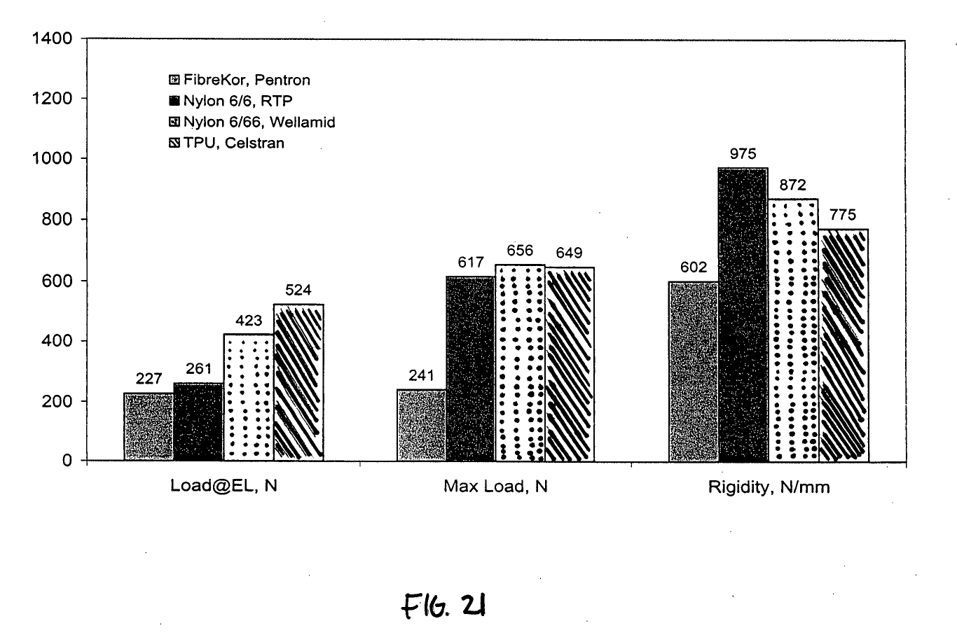

The fibers may be randomly dispersed in the resin matrix in any area of the block such as on the skin or surface of the blocks as shown in FIG. 16, and may be oriented in a certain direction in any area of the block such as oriented longitudinally along the length of the block and oriented in a curved formation at the ends of the block in the inner surface of the block as shown in FIG. 17. It is also preferable that the fibers have lengths in the range from about 5 nm to about 15 mm and more preferably in the range from about 3 to about 11 mm and most preferably in the range of about 5 to about 7 mm in length. This length provides a good working length and reduces the amount of fibers that may extend beyond the length of the matrix after cutting or machining has occurred. The flexural strength of the composite blocks when measured by ISO 10477 and modifications thereof at a span length of 20 mm for samples with dimensions of 1×2×25 mm and 2×2×25 mm is in the range of about 160 to about 400 MPa. The flexural modulus of the composite blocks when measured by ISO 10477 and modifications thereof is in the range of from about 6 to about 15 GPa for samples with dimension of 2×2×25 mm and in the range from about 7 to about 19 GPa for samples with dimensions of 1×2×25 mm. This is an improvement over composite blocks having fibers distributed in one direction only.

The glass transition temperature of the fiber-reinforced composite material is preferably greater than about 37° C., more preferably greater than about 45° C., and most preferably greater than about 55° C. This glass transition temperature is important because during application of a veneer material, the understructure must be able to withstand certain curing temperatures of the veneer. Having a glass transition temperature above 37° C. will prevent slumping of the understructure during application of the veneer material.

Fabric may also be combined with the fiber-reinforced composite material in certain instances to produce a high strength appliance. Fabric may be of the woven or non-woven type as discussed above and is preferably preimpregnated with a polymeric material. Suitable polymeric materials are those listed above as polymeric matrix materials.

In accordance with one embodiment of the present invention, the fiber-reinforced polymeric composite material is preformed into structural components to provide ready-to-use units for use in the fabrication of dental appliances. The structural components are formed into any known shape(s) useful in the fabrication of a dental appliance or restoration. Preferably, the structural components are in the shape of bars or pontics. The pontics have interproximal extensions and may be single unit or multiple unit useful in the fabrication of frameworks for bridges. The bars and pontics may be straight or curved depending on the end use. The structural components may be “ready-to-use” for immediate use in the fabrication of a dental appliance or restoration or may be further modified, for example by cutting, carving or grinding prior to using in the fabrication of a dental appliance or restoration.

The fiber-reinforced polymeric matrix may further comprise at least one filler known in the art and used in dental restorative materials, the amount of such filler being determined by the specific use of the fiber-reinforced composite. Generally, no or relatively little additional filler is present in the polymeric matrix, i.e., up to thirty percent by weight of the composite. Suitable fillers are those capable of being covalently or physically bonded to the polymeric matrix itself or to a coupling agent that is covalently or physically bonded to both. Examples of suitable filling materials include but are not limited to those known in the art such as silica, silicate glass, quartz, barium silicate, strontium silicate, barium borosilicate, strontium borosilicate, borosilicate, lithium silicate, amorphous silica, ammoniated or deammoniated calcium phosphate, carbon black, alumina, zirconia, tin oxide, and titania. Particularly suitable fillers for dental filling-type materials prepared in accordance with this invention are those having a particle size ranging from about 0.1-5.0 microns with a silicate colloid of 0.001 to about 0.07 microns and may be prepared by a series of milling steps comprising wet milling in an aqueous medium, surface etch milling and dry or wet silanation. Some of the aforementioned inorganic filling materials are disclosed in commonly-assigned U.S. Pat. Nos. 4,544,359 and 4,547,531 to Waknine, the pertinent portions of which are incorporated herein by reference.

The particulate-filled polymeric matrix comprises at least one filler known in the art and used in dental restorative materials, the amount of such filler being determined by the specific use of the particulate-filled composite. Generally, from about 65 to about 85% by weight of a filler is present in the particulate-filled composite and preferably, about 75 to about 83% by weight of the composite is filler in combination with about 17 to about 35% by weight and preferably about 20 to about 30% by weight and more preferably about 20 to about 26% by weight of the composite is unfilled heat curable dental resin material which makes up the polymeric matrix. Suitable fillers are those capable of being covalently or physically bonded to the polymeric matrix itself or to a coupling agent that is covalently or physically bonded to both. Examples of suitable filling materials include but are not limited to those known in the art such as silica, silicate glass, quartz, barium silicate, barium sulfate, barium molybdate, barium methacrylate, barium yttrium alkoxy (Ba₂Y(OR)ₓ), strontium silicate, barium borosilicate, strontium borosilicate, borosilicate, lithium silicate, amorphous silica, ammoniated or deammoniated calcium phosphate, alumina, zirconia, tin oxide, tantalum oxide, niobium oxide, and titania. Particularly suitable fillers for dental filling-type materials prepared in accordance with this invention are those having a particle size ranging from about 0.1-5.0 microns with a silicate colloid of 0.001 to about 0.07 microns and may be prepared by a series of milling steps comprising wet milling in an aqueous medium, surface etch milling and dry or wet silanation. Some of the aforementioned inorganic filling materials are disclosed in commonly-assigned U.S. Pat. Nos. 4,544,359 and 4,547,531 to Waknine, the pertinent portions of which are incorporated herein by reference.

Preferably, the particulate-filled composite comprises an inorganic filler having an average particle size diameter of about 0.5 to about 5 microns homogeneously dispersed in a thermoplastic polyurethane or a polyamide. In addition, a relatively small amount of fumed silica is also predispersed within the monomeric matrix. The inorganic filler primarily comprises an X-ray opaque alkali metal or alkaline earth metal silicate such as lithium alumina silicate, barium silicate, strontium silicate, barium borosilicate, strontium silicate, barium borosilicate, strontium borosilicate, borosilicate, as well as the aforementioned materials. For purposes of illustration, and as the preferred silicate species, barium borosilicate will hereinafter be employed as being typical of the alkali metal or alkaline earth metal silicates which can be suitably employed in the present invention. The barium borosilicate exhibits an index of refraction close to that of the organic monomeric matrix in which it is dispersed. The filler can additionally contain a relatively small amount of borosilicate glass, which imparts greater compressive strength to the resulting composite and enhances the translucency thereof thereby enabling better blending of the restorative material with the adjacent teeth. In addition, the presence of the borosilicate glass helps narrow the gap in the mismatch of refractive indices between the barium borosilicate inorganic fiber phase and the organic monomeric matrix.

Details of the preparation of the inorganic filler, which comprises a mixture of from about 5 to about 20% by weight of borosilicate glass and form about 80 to about 95% by weight barium borosilicate, and has an average particle size diameter of from about 0.5 to about 5 microns, can be found in the aforementioned U.S. Pat. Nos. 4,544,539 and 4,547,531.

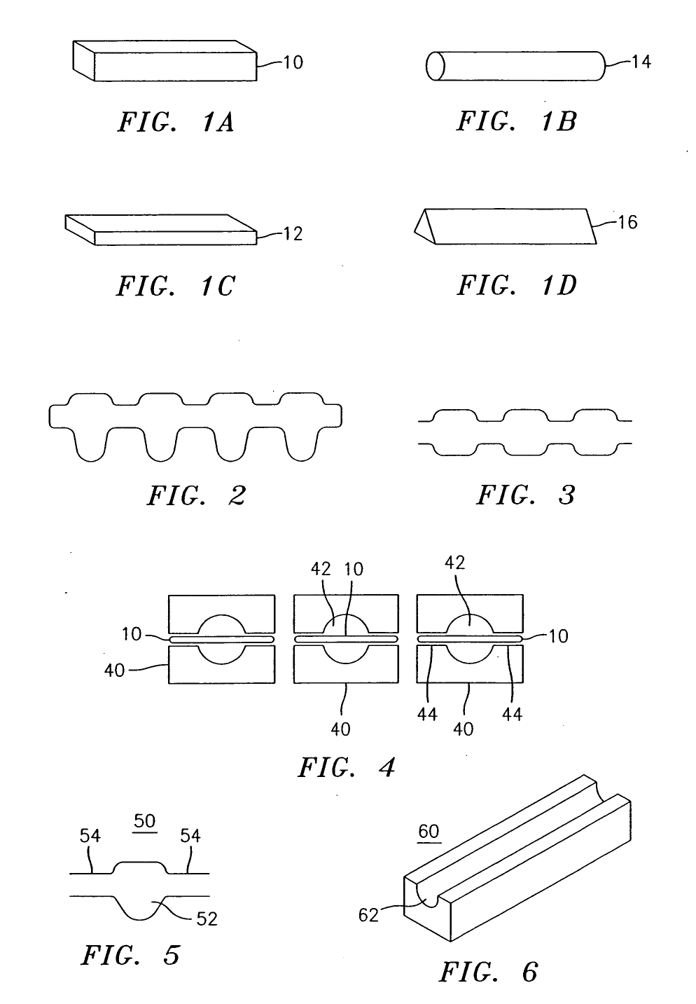

FIG. 1 shows various shapes of bars formed in accordance with the present invention. FIGS. 1A through 1D depict bars of square 10, circular 12, rectangular 14 and triangular 16 cross-section, respectively. Structural components in the form of bars are typically used in the manufacture of dental bridges or posts. If posts are desired, the cross-sectional dimension of the post must be narrow enough to fit within the root canal.

More complicated shapes of preformed structural components may be formed from the structural bars either manually or mechanically by carving, cutting, grinding, machining or using other similar means. The complicated shapes may include pontics and frameworks of varying lengths and shapes as noted above and as shown in FIGS. 2, 3 5, 18 and 19, but are not limited to the specific shapes shown. FIGS. 18 and 19 are directed to a framework for a three unit bridge, FIG. 18 is a cross-sectional side view and FIG. 19 is a top plan view of FIG. 18. Alternatively, the complicated shapes may be formed by compression molding of the composite materials and fully or partially curing into a hardness sufficient to withstand cutting, carving or machining. In a preferred embodiment, preformed structural bars are placed within a series of molds and composite material is filled into the cavities surrounding the bars to form a single unit pontic 50 as shown in FIG. 5.

FIG. 2 shows a multiple unit pontic 20 that may be used in the preparation of an anterior bridge. FIG. 3 displays a multiple unit pontic 30 that could be used in the preparation of a bridge.

FIG. 4 depicts a series of molds 40 having cavities 42 therein connected to laterally extending thin sections 44. FIG. 6 shows a single mold 60 have a longitudinally extending cavity 62 used to fabricate a long bar that may be cut into smaller sections after it has cured. In accordance with one process of the present invention, one or more layers of filled composite material may be poured into cavities 42. Preferred composite materials are available from Pentron Clinical Technologies, LLC, Wallingford, Conn., under the trademarks FLOW-IT and LUTE-IT. One or more layers of pre-impregnated woven or nonwoven fabric may be placed on the composite layer(s). Alternately, the fabric may be first placed in the cavities 42 and composite material may be deposited thereover. After the composite and/or fabric is provided in cavities 42, preformed structural bars 10 may be placed within mold 40 as shown. More composite material may be used to fill any voids in cavities 42. The material is cured to form a structural component in the shape of a single unit pontic 50 having a central pontic section 52 and laterally extending arms 52. Preferably, the molded component is cured to a sufficient hardness whereby it may be machined or carved to a desired final shape by the technician or dentist during fabrication of the dental appliance. The molded component may be partially cured at the time of fabrication and the curing can be completed at the time of fabrication of the dental appliance or the molded component may be fully cured at the time of manufacture thereof. Mold 60 may be used in a similar fashion to molds 40 to prepare a long bar that may cut into smaller sections after it has cured.

In accordance with the invention herein, the composites are formed into pieces or blocks of fiber-reinforced or particulate-filled composite material. Commercially available Fiberkor® composite available from Jeneric/Pentron Inc., Wallingford, Conn. may be used to fabricate the fiber-reinforced composite blocks and commercially available Sculpture® composite from Jeneric/Pentron Inc., Wallingford, Conn. may be used to fabricate the particulate filled composite blocks. Commercially available thermoplastic resins useful for the manufacture of blocks, bars and pontics include, but are not limited to, OXPEKK-C30G™ available from OPM; PEEK 459GL30™ available from Victrex; Wellamid™ available from Wellman Inc.; Verton™ available from LNP; RTP 211 HS™ available RTP; Durethan BKV 50 H™ available from Bayer; Stanyl TW241F10™ available from DSM; Fortron 1140 L4™, Fortron 6165 A4™, CELSTRAN™, Celanex 5300™, all available from Ticona; Plenco 50045™ available from Plenco; and Zenite LCP 7130(L)™ available from Dupont. The blocks of material may be of a variety of shapes and sizes and may be modified by a variety of methods including but not limited to machining, carving, cutting, grinding, abrading or etching.

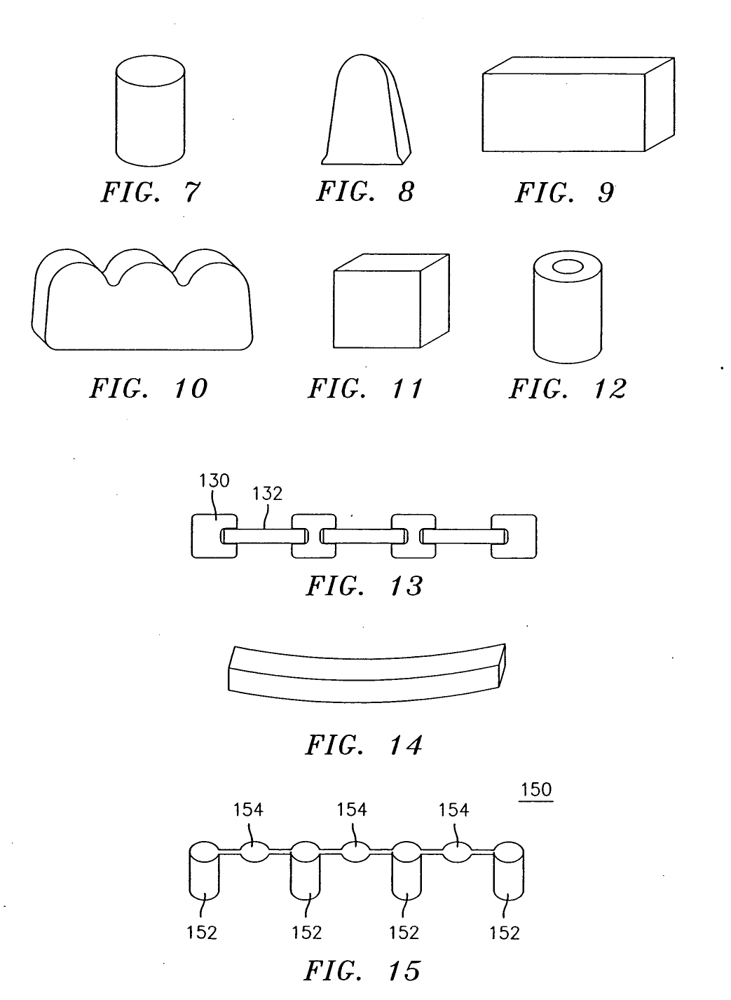

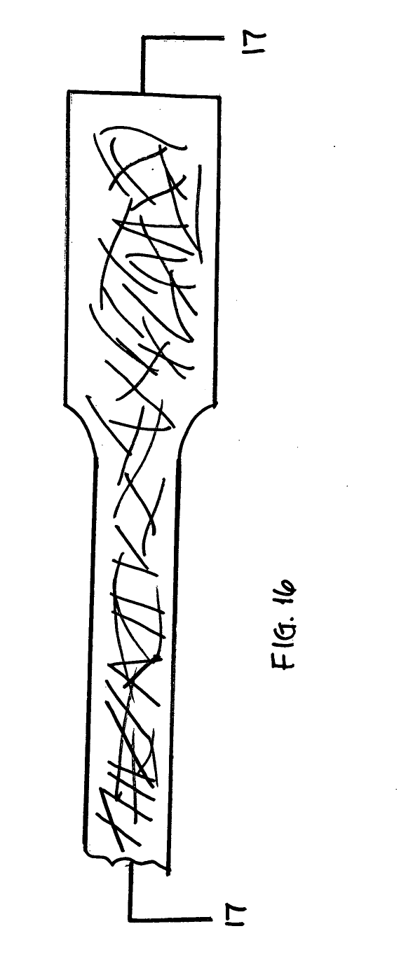

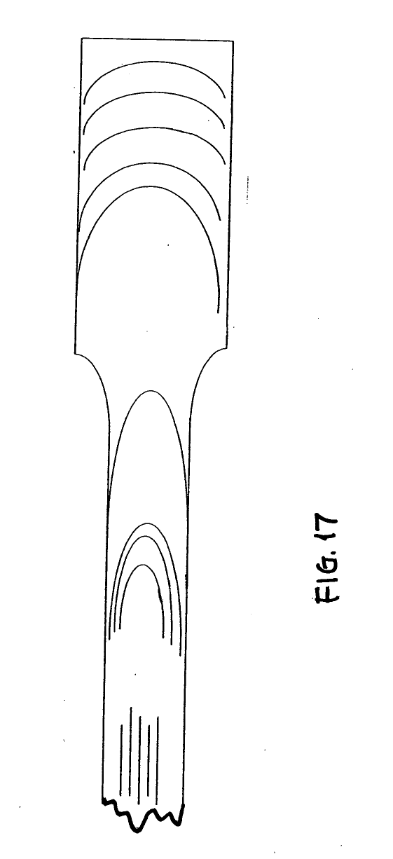

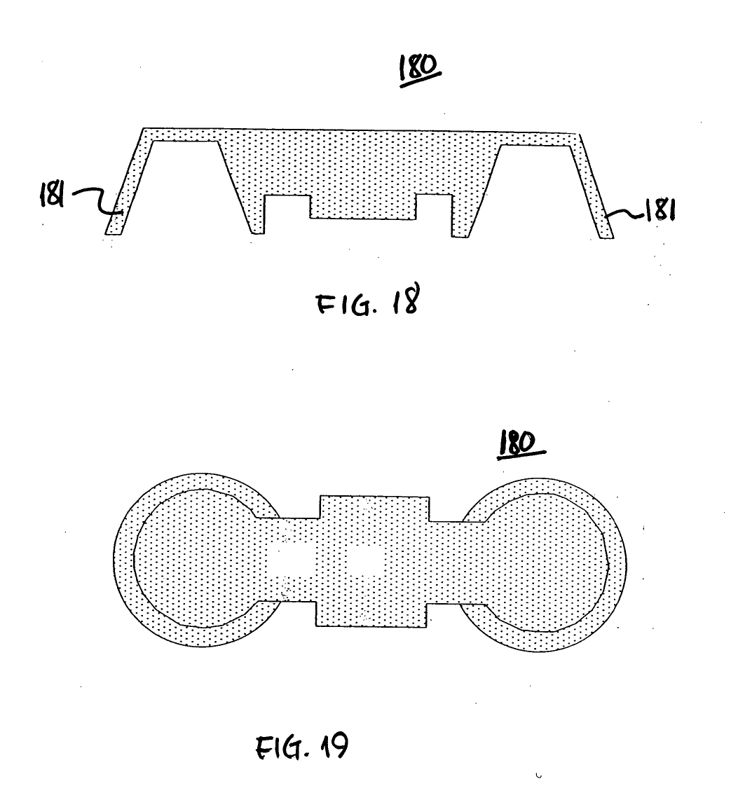

FIGS. 7, 9 and 11 depict blocks formed in accordance with the present invention. FIG. 7 shows a cylindrical block, FIG. 9 shows a rectangular block and FIG. 11 shows a square block. FIG. 8 depicts a tooth which has been machined from the block shown in FIG. 7. FIG. 10 shows a bridge machined from the block in FIG. 9. FIG. 12 shows a cylinder for use is an implant machined from the block in FIG. 11.

The cylinder shown in FIG. 12 can be used in combination with prefabricated bars of the present invention or may be used with uncured fiber-reinforced composite material such as Fiberkor® available from Jeneric/Pentron Inc., Wallingford, Conn. An implant may be manufactured with one or all of its components fabricated from the structural components of the present invention including but not limited to the abutments, cylinders, retainers and framework. The resulting implant components provide good shock absorbency. Preferably the implant components are machined out of blocks fabricated in accordance with the present invention. The machined blocks may include retentive designs on the eternal service for proper linkage to create multi-unit bridges or to reinforce bonding to the overlay composite materials. The implant superstructure may additionally include pontic components for proper support of the overlay material. As one example, the implant system could include a retainer that is machined to match the shape of the abutment to which it will attach. FIG. 13 shows a partial implant system wherein cylinders 130 and bars 132 are disposed therebetween to form the superstructure. Cylinders 130 are preferably machined from blocks made in accordance with the present invention. Bars 132 are likewise manufactured in accordance with the present invention.

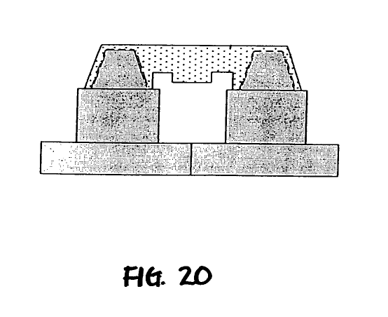

FIGS. 14 shows a curved rectangular block formed in accordance with the present invention. FIG. 15 shows an implant superstructure 150 which has been machined from the block shown in FIG. 14. Superstructure 150 comprises cylinders 152 interconnected with pontic sections 154.

In accordance with the method of the present invention, the components may be manufactured continuously on line as part of the fiber impregnation process or may be molded into shapes after the impregnation process. In a preferred embodiment of the invention, components in the form of, for example, bars or blocks may be manufactured following the process of fiber impregnation with a matrix material. The bars or blocks are preferably formed under pressure and undergo either full or partial polymerization to impart specific properties for specific applications. Long, continuous bars or blocks may be molded and cured to a hardness sufficient to withstand cutting, carving or machining and subsequently cut into the desired lengths at the time of manufacture or at some point thereafter. The cross-section of the structural components may be square, rectangular, triangular, rhomboidal, ovoidal, tapered, cylindrical, or of any other cross-sectional configuration effective to provide strength and stiffness to the finished dental appliance. The dimensions may be of varying lengths, widths and heights and the shades thereof may be of any shade suitable for dental materials. Coloring agents known in the art may be added to the polymeric matrix material prior to curing.

The components may be used as frameworks or understructures for crowns, bridges, implant abutment cylinders, implant superstructures and the like. The framework/understructure can be made from the structural components in a variety of ways. The method of fabrication may be manual or automated. In the manual method, a technician can select a component of, for example, rectangular shape. The technician cuts the block to proper dimension and size and carves out the desired anatomical features using standard laboratory tools.

To perform the procedure by automated or mechanical means, an apparatus such as a CAD/CAMming machine is used to automatically shape the structural component into the form or contour desired. The component is preferably in the form of a block (also known as a blank) for CAD/CAMming purposes. The technicians and/or practitioners collect three dimensional data regarding the final desired shape of the dental appliance or restoration and machine or mill the block or blank to achieve the final desired shape. The data may be collected from actual teeth, implants, etc. or from models or prefabricated frameworks (of wax, duralay, etc.) prepared on teeth or stone models or from an impression taken of the tooth or teeth to be corrected by using a scanning device such as the Pro-Scan™ device available from IntraTech in Irving, Tex. The data may be used as is or may be modified using computer software. Based on the data, the blank is machined via CAM to a three-dimensional dental appliance or material. The CAD/CAM process may be performed at one location or the CAD data may be transferred via modem or electronic transmission to another location where computer assisted machining or milling is performed. The machined part may be further modified or treated with for example, a surface treatment such as abrasion, etching, or silanation, or with a special bonding agent. Additionally, the machined part can be joined with other preimpregnated fiber-reinforced materials prior to being overlaid with a coating or veneer. The veneer may be a particulate-filled composite material such as commercially available Sculpture® material available from Jeneric/Pentron Inc., Wallingford, Conn. and is preferably applied to the machined or manually carved part to provide the final anatomy. The finished appliance or restoration can either be bonded or mechanically anchored. Bonding is the preferred fastening means.

The prefabricated, preshaped cured components of the present invention can substantially eliminate operator-induced errors, greatly save time and enhance overall properties and longevity of final restorations. For implant restorations, replacement of the rigid (high modulus) metal components with a lower modulus material of the fiber-reinforced composite structural components, improves shock absorption.

The following examples illustrate the invention:

### EXAMPLES

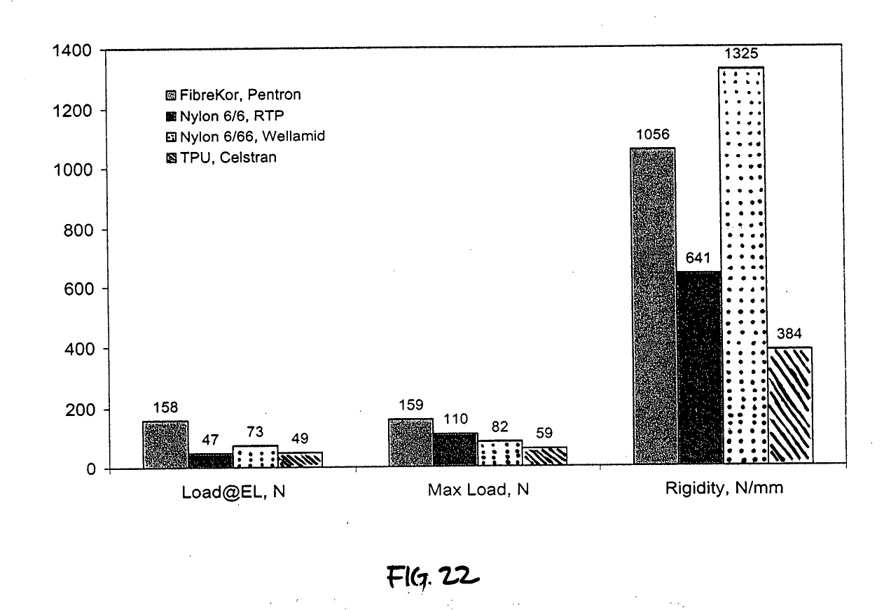

Blocks of glass fiber reinforced thermoplastic polymers were fabricated of thermoplastic polyurethane available from Ticona as Celstran TPU-GF60-01™, nylon 6/66 available from Wellman as Wellamid GF 60-66/6-XE-N™ and nylon 6/6 available from RTP Company as RTP 211 HS™. The blocks were machined into clinically representative dimensions using a computer-assisted CNC milling machine. The machined frameworks 180 are shown in FIGS. 18 and 19. All the frameworks were the same in all dimensions except in the retainer areas at each end which had a thickness of either 0.75 mm or 1.25 mm denoted in FIG. 18 as 181. The machined frameworks were tested for mechanical properties and compared with non-machined specimens of fiber-reinforced composite material fabricated by hand using FibreKor® material available from Pentron Laboratory Technologies, LLC, which is a continuous glass fiber-reinforced dimethacrylate composite. The hand-fabricated frameworks were made as identical as possible to the dimensions of the machined frameworks. The internal retainer dimensions on all the bridges were matched to a set of steel dies used in the testing procedure as shown in FIG. 20. The assembly with the die and substructure thereon was placed in a universal testing machine (MTS 858 Mini Bionix II) and a load was applied on the central pontic region with a 1.0 mm radius blade indentor.

Several of the thermoplastic polyurethane and nylon frameworks were bonded to the steel dies prior to testing. A thin layer of an adhesive (Bond-1 bonding material available from Pentron) was brushed onto the internal surfaces of the retainers, the frameworks were placed on the dies with firm hand pressure and allowed to dry for 20 minutes prior to testing.

The results of the mechanical tests are shown in FIGS. 21 and 22. As shown in FIG. 21, for the samples having 1.25 mm thickness, all of the machined frameworks had superior rigidity and resistance to deformation in comparison to the hand-fabricated frameworks. As shown in FIG. 22, for the samples having 0.75 mm thickness, the hand-fabricated frameworks were somewhat better in resistance to deformation, but some of the machined frameworks exhibited better rigidity.

As will be appreciated, the present invention provides preshaped, prefabricated cured components having optimum strength. The components may be ready-to-use structural components, structural components which may or may not be further modified prior to use, or components which must be further modified prior to use. The components are provided of varying shapes and sizes offering many options to the technician or practitioner in the fabrication of dental appliances. Due to the many different shapes, sizes and contours of teeth, a kit may be provided including ready-to-use structural components in the shape of pontics and bars of varying configurations and sizes to offer the technician and practitioner options with which to construct dental appliances. Accordingly, custom made dental appliances can be easily fabricated using the ready-to-use structural components. The ready-to-use components may be further modified prior to fabrication of a dental appliance or restoration. Kits may also be provided with component blocks of varying shapes, sizes and colors offering many options to the technician and practitioner.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A prefabricated block for use in a CAD/CAM system for the manufacture of a dental appliance comprising:
a fiber-reinforced composite material comprising fibers dispersed in a thermoplastic matrix material;
wherein the fibers are less than about 15 mm in length;
wherein the fibers are not fully aligned in one direction; and
wherein the fibers are randomly dispersed in at least a section of the block.

2. The prefabricated block of claim 1 wherein the glass transition temperature of the fiber-reinforced composite material is greater than about 37° C.

3. The prefabricated block of claim 1 wherein the fibers are aligned in one or more directions in at least a section of the block.

4. The prefabricated block of claim 1 wherein the thermoplastic matrix material comprises polyamides, thermoplastic polyesters, thermoplastic polyurethanes, polyethylenes, vinyl esters, polyethers, polyphenylenes, polysulfones, polycarbonates, polypropylene, polystyrenes, polystyrene acrylonitriles, polymethacrylates, polyacrylates, polyketones, liquid crystalline polymers, polysiloxanes, polyphosphazenes, or mixtures thereof.

5. The prefabricated block of claim 4 wherein the polymethacrylates comprise polymethacrylate, poly(methyl methacrylate), poly(ethyl methacrylate), other poly(n-alkyl methacrylates), poly(t-butyl methacrylate), or mixtures thereof.

6. The prefabricated block of claim 4 wherein the polyphenylenes comprise polyphenylene sulfide.

7. The prefabricated block of claim 4 wherein the polyethers comprise polyether ketone ketone, polyetherether ketone, or mixtures thereof.

8. The prefabricated block of claim 4 wherein the polyamides comprise nylon 6/66, nylon 6/6, nylon 6, nylon 4/6, nylon 11, nylon 12, nylon 46, nylon 610, nylon 612, aromatic polyamides (aramids), or mixtures thereof.

9. The prefabricated block of claim 4 wherein the polyethylenes comprise polyethylene terephthalate.

10. The prefabricated block of claim 4 wherein the polybutylenes comprise polybutylenes terephthalate.

11. The prefabricated block of claim 1 wherein the thermoplastic matrix material comprises a random, block, or graft copolymer, or a mixture thereof.

12. The prefabricated block of claim 1 wherein the thermoplastic matrix material comprises a random, block, or graft ionomer, or a mixture thereof.

13. The prefabricated block of claim 1 wherein the fibers comprise glass, carbon, polyaramid, ceramic, polyester, polyamide or a mixture thereof.

14. The prefabricated block of claim 13 wherein the carbon fibers are selected from the group consisting of graphite fibers and nano-carbon tubes.

15. The prefabricated block of claim 1 wherein the fibers are present in lengths in the range from about 5 nm to about 11 mm.

16. The prefabricated block of claim 1 further comprising a particulate filler.

17. The prefabricated block of claim 16 wherein the particulate filler comprises silica, silicate glass, quartz, barium silicate, strontium silicate, barium borosilicate, barium sulfate, barium molybdate, barium methacrylate, barium yttrium alkoxy (Ba₂Y(OR)ₓ), strontium borosilicate, borosilicate, lithium silicate, amorphous silica, ammoniated or deammoniated calcium phosphate, alumina, zirconia, tin oxide, tantalum oxide, niobium oxide, titania or a mixture thereof.

18. The prefabricated block of claim 16 wherein the particulate filler comprises particles in the range of about 5 nm to about 7 microns.

19. The prefabricated block of claim 18 wherein the particulate filler comprises particles in the range from about 0.5 to about 5 microns.

20. The prefabricated block of claim 17 wherein the particulate filler comprises a mixture of from about 5 to about 20% by weight of borosilicate glass and from about 80 to about 95% by weight of barium borosilicate.

21. The prefabricated block of claim 1 wherein the dental appliance is selected from the group consisting of orthodontic retainers, bridges, space maintainers, tooth replacement appliances, splints, crowns, partial crowns, dentures, posts, teeth, jackets, inlays, onlays, facings, veneers, facets, implants, abutments, retainers, cylinders, and connectors

22. The prefabricated block of claim 1 wherein the block is provided in the shape of a pontic or bar.

23. A prefabricated block for use in a CAD/CAM system for the manufacture of a dental appliance comprising:
a fiber-reinforced composite material comprising fibers dispersed in a thermoplastic matrix material;
wherein the fibers are less than about 15 mm in length;
wherein the fibers are not fully aligned in one direction;
wherein the fibers are randomly dispersed in at least a section of the block; and
wherein the glass transition temperature of the fiber-reinforced composite material is greater than about 37° C.

24. A prefabricated block for use in a CAD/CAM system for the manufacture of a dental appliance comprising:
a fiber-reinforced composite material comprising fibers dispersed in a thermoplastic matrix material;
wherein the fibers are less than about 15 mm in length;
wherein the fibers are not fully aligned in one direction;
wherein the fibers are randomly dispersed in at least a section of the block;
wherein the glass transition temperature of the fiber-reinforced composite material is greater than about 37° C.; and
wherein the fibers are aligned in one or more directions in at least a section of the block.

25. A dental appliance manufactured from the prefabricated block of claim 1.

26. A dental appliance manufactured from the prefabricated block of claim 23.

27. A dental appliance manufactured from the prefabricated block of claim 24.

28. The dental appliance of claim 22 selected from the group consisting of orthodontic retainers, bridges, space maintainers, tooth replacement appliances, splints, crowns, partial crowns, dentures, posts, teeth, jackets, inlays, onlays, facings, veneers, facets, implants, abutments, retainers, cylinders, and connectors.

29. The dental appliance of claim 23 selected from the group consisting of orthodontic retainers, bridges, space maintainers, tooth replacement appliances, splints, crowns, partial crowns, dentures, posts, teeth, jackets, inlays, onlays, facings, veneers, facets, implants, abutments, retainers, cylinders, and connectors.

30. A dental appliance manufactured from a prefabricated block comprising a fiber-reinforced composite material comprising fibers dispersed in a thermoplastic matrix material; wherein the fibers are less than about 15 mm in length; wherein the fibers are not fully aligned in one direction; and wherein the fibers are randomly dispersed in at least a section of the block.

31. A dental appliance manufactured from a prefabricated block comprising a fiber-reinforced composite material comprising fibers dispersed in a thermoplastic matrix material; wherein the fibers are less than about 15 mm in length; wherein the fibers are not fully aligned in one direction; wherein the fibers are randomly dispersed in at least a section of the block; and wherein the glass transition temperature of the fiber-reinforced composite material is greater than about 37° C.

32. A dental appliance manufactured from a prefabricated block comprising a fiber-reinforced composite material comprising fibers dispersed in a thermoplastic matrix material; wherein the fibers are less than about 15 mm in length; wherein the fibers are not fully aligned in one direction; wherein the fibers are randomly dispersed in at least a section of the block; wherein the glass transition temperature of the fiber-reinforced composite material is greater than about 37° C.; and wherein the fibers are aligned in one or more directions in at least a section of the block.

33. A method of making a dental appliance comprising:
providing a prefabricated block of material comprising a fiber-reinforced composite material comprising fibers dispersed in a thermoplastic matrix material; wherein the fibers are less than about 15 mm in length; wherein the fibers are not fully aligned in one direction; and wherein the fibers are randomly dispersed in at least a section of the block; and
machining the block into the dental appliance.

34. The method of claim 33 wherein the dental appliance is selected from the group consisting of orthodontic retainers, bridges, space maintainers, tooth replacement appliances, splints, crowns, partial crowns, dentures, posts, teeth, jackets, inlays, onlays, facings, veneers, facets, implants, abutments, retainers, cylinders, and connectors.

35. A method of making a dental appliance comprising:
providing a prefabricated block of material comprising a fiber-reinforced composite material comprising fibers dispersed in a thermoplastic matrix material; wherein the fibers are less than about 15 mm in length; wherein the fibers are not fully aligned in one direction; wherein the fibers are randomly dispersed in at least a section of the block; and wherein glass transition temperature of the fiber-reinforced composite material is greater than about 37° C.; and
machining the block into the dental appliance.

36. The method of claim 35 wherein the dental appliance is selected from the group consisting of orthodontic retainers, bridges, space maintainers, tooth replacement appliances, splints, crowns, partial crowns, dentures, posts, teeth, jackets, inlays, onlays, facings, veneers, facets, implants, abutments, retainers, cylinders, and connectors.

37. A method of making a dental appliance comprising:
providing a prefabricated block of material comprising a fiber-reinforced composite material comprising fibers dispersed in a thermoplastic matrix material; wherein the fibers are less than about 15 mm in length; wherein the fibers are not fully aligned in one direction; wherein the fibers are randomly dispersed in at least a section of the block; wherein glass transition temperature of the fiber-reinforced composite material is greater than about 37° C.; and wherein the fibers are aligned in one or more directions in at least a section of the block; and
machining the block into the dental appliance.

38. The method of claim 37 wherein the dental appliance is selected from the group consisting of orthodontic retainers, bridges, space maintainers, tooth replacement appliances, splints, crowns, partial crowns, dentures, posts, teeth, jackets, inlays, onlays, facings, veneers, facets, implants, abutments, retainers, cylinders, and connectors.
